(19) United States
(12) Patent Application Publication
(10) Pub. No.: US 2004/0230449 A1
(43) Pub. Date: Nov. 18, 2004

(54) On-line transactional display with multiple data type entry facility

(76) Inventor: Robert B. Franks, Sheffield (GB)

Correspondence Address: HARNESS, DICKEY & PIERCE, P.L.C., P.O. BOX 828, BLOOMFIELD HILLS, MI, 48303, US

(21) Appl. No.: 10/781,924

(22) Filed: Feb. 18, 2004

(30) Foreign Application Priority Data
Aug. 18, 2001 (GB) 0120213.4

(51) Int. Cl. H04N 7/16

(52) U.S. Cl. 705/1; 725/1

(57) ABSTRACT

There is disclosed an interface and architecture for a transaction system capable of collecting data for filing of intellectual property rights, which includes provision for collecting text data, image data, audio data, and/or video data, and supplying that data to a service provider in a form which enables the service provider to apply for legal protection for that data.

### FIELD OF THE INVENTION

The present invention relates to on-line transactional systems, and particularly although not exclusively to an interface and architecture of an on-line transactional system for receiving instructions for filing of intellectual property rights

### BACKGROUND OF THE INVENTION

The internet operates by a system of URL addresses, being unique codes which identify individual computer devices. A typical URL consists of a sequence of numbers which can be assigned to a particular computer entity as that computer entity's internet address. However, URLs are more or less meaningless to typical human users of the internet, being simply a sequence of numbers with no readily understandable meaning. Consequently, domain names have been created which comprise text characters in a form more understandable to humans. Domain names include such things as personal names, company names, invented names and the like. Domain names are assigned to individual URLs by a central authority, and domain names can be applied for by natural persons and legal entities on a first come first served basis. Typically to apply for a domain name registration, a user accesses a web site, types in the required domain name into a search engine, the search engine compares that domain name with a list of already assigned or reserved domain names, and if an identical match is found, registration is not available. Registration of domain names is based upon a simple comparison of a first text string representing an applicant's desired domain name, with a series of second text strings, representing domain names which have already been registered to other users. The comparison of first and second text strings is to find an identical match (where upper case and lower case characters are assumed identical and the matching process is case independent).

In the early days of the internet, domain name registration was a relatively simple process: the domain name was either available, i.e. not already registered to someone else, or was unavailable i.e. already registered to someone else. However, subsequently the legal protection of domain names has become more legalistic, as owners of pre-existing trade marks and brands have challenged domain name registrations of third parties which are identical or similar to those trade marks or brands. However, the basic process for registration of domain names is still on a first to file basis.

On the other hand, legal protection of trade marks has a history going back centuries, and has always been fragmented, with each country or state having its own trade mark laws and system for registration of trade marks. There is a legacy history of different legal systems, and different registration processes in each country or state, which has given rise to separate legal specialisms in each state, with legal practitioners practicing as trade mark attorneys, knowing the individual quirks of each legal system under which they operate. Whilst domain name registration has, from the outset, being carried on on-line and remotely, historically, trade mark registration is a paper based system, which is time consuming and non uniform throughout the world. However, for some legal systems, notably the United Kingdom and Europe, the trade mark registration process is becoming easier, with examination requirements and search requirements being relaxed.

Consequently, whilst domain name registration and trade mark registration are still two very different procedures, there is convergence between the two procedures in that domain name registration is becoming more legalistic, whilst trade make registration is becoming less legalistic.

Filing a trade mark application is an intrinsically complex process, due to the wide variety of information parameters which need to be collected in order to complete a filing, and due to the various permutations of legal protocols and procedures which can be used. For obtaining trade mark protection, conventionally a client instructs a trade mark attorney or solicitor by telephone, who then advises on a best course of action, and enters a sometimes lengthy correspondence concerning cost, goods and services, and advice on various options for achieving the same filing objective. Whilst it is possible to achieve a trade mark instruction by a single telephone call from a client, it is still common for a client wishing to register a trade mark to experience delays of days, weeks, months, or in bad cases even years between initial contact with a legal practitioner, and a trade mark application actually being filed at a government office.

More recently, It is known to find on the internet web sites through which a trade mark application can be made. Some of these web sites are operated by commercial organisations, that is trade mark attorneys and law firms, whilst others are operated by government offices themselves, for example the Canadian Trade Marks Office. An example of a prior art commercial web site for applying for trade mark rights over the internet is trademarksonline.com. This web site allows filing of a trade mark application in a single country. Details of the mark, specification of goods or services, applicant name and address, and credit card details are input into the web site on-line by a user.

A basic technical problem is how to provide an interface which collects the bare minimum amount of information in order to successfully automatically complete an order, without the process reverting to an off line process. Once a process reverts to a non automated off line process, then the costs associated with dealing with a trademark filing escalate rapidly, and the probability of achieving a successful order reduce, compared to the certainty of an automated online order for filing a registered trademark application.

Problems which need to be overcome to provide a user interface capable of receiving instructions to file a trade mark application include:

Users of the system have a range of modern and/or legacy browsers, and have a range of monitor visual display sizes. Typically, in a worst case a user may have an out of date browser, and a small 15 inch (38 centimeter) diagonal monitor, giving a small visual area in which to display information describing a selection of countries, and allowing little space for entry of data describing a trade mark.

An operator of an on-line service for filing intellectual property rights has no control of the browsers or visual display devices of the users, and must design a system which works well with a wide variety of browsers and monitor screens.

A significant barrier to implementing an on-line trade mark registration service, is the wide variety of signs or indications which can be classified as a trade mark. For example, under European trade mark law, sounds, smells, images such as logos or devices, shapes, smells, colors, words and personal names, can all be registered as trade marks, provided they are capable of distinguishing between the origins of goods and services. Designing an interface which is easy to use, and which is capable of inputting data describing any type of trade mark is a technically challenging problem.

To the best of the inventor's knowledge, there is no on-line interface, which is capable of handling any type of representation of a trade mark for which legal protection may be sought.

### SUMMARY OF THE INVENTION

Specific implementations of the present invention aim to provide an on-line interface, remotely accessible over a communications network, allowing a user to enter details describing a trade mark, and capable of handling different types of trade mark, including color marks, sound marks, smell marks, image devices and logos, as well as text marks, and to supply a data file to a service provider, in a form which enables the service provider to define the mark accurately through the received data.

According to a first aspect of the present invention there is provided an interface, for inputting data describing a trademark said interface comprising:

a data file input component, for inputting a selected data file, said selected data file comprising data describing a trade mark; and

a browse component for enabling a user to browse a file system of a user computer entity, and select said data file from said file system.

According to a second aspect of the present invention there is provided a transaction system for collecting data describing a trade mark, said transaction system comprising:

a transaction computer entity, said transaction computer entity operating an interface, said interface capable of accepting a data file representing a trade mark;

at least one user computer entity, said user computer entity comprising a browser, and a file system;

wherein said interface allows said browser to:

browse said file system of said user computer entity;

select a data file stored on a data storage device of said user computer entity; and

said interface inputs said selected data file to said transaction computer entity.

According to a third aspect of the present invention there is provided a transaction system for collecting data describing a trade mark, said transaction system comprising:

a transaction computer entity, said transaction computer entity operating an interface, said interface capable of accepting an image data file;

wherein said interface is capable of serving a view of an image contained in said input image data file.

According to a fourth aspect of the present invention there is provided a display interface for inputting a data describing a trade mark, said data display interface comprising:

a text data entry component, capable of entering a text string comprising said trade mark;

a trade mark description data entry component, capable of inputting text data describing said trade mark;

an image data input component, capable of inputting an image data file, said image data describing said trade mark; and

an audio data input component, capable of inputting an audio data file, said audio data file comprising audio data describing said trade mark.

According to a fifth aspect of the present invention there is provided a display interface for inputting data describing a trade mark, said display interface comprising:

at least one data entry component, said data entry component capable of accepting data in a form selected from the set:

text data;

image data;

video data;

audio data.

According to a sixth aspect of the present invention there is provided a method of inputting data describing a trade mark, said method comprising:

generating a display view, said display view showing one or a plurality of data entry components, for entering data describing a trade mark, wherein said data describing a trade mark can be of a data type being any one or more of the following data types:

text character data;

image data;

audio data;

video data.

According to a seventh aspect of the present invention there is provided an electronic order data file capable of being printed in graphical format, said order data file comprising:

a field for containing a set of text characters comprising said trade mark;

a field containing a text description of said trade mark; and

a field containing a graphical image of said trade mark.

According to an eighth aspect of the present invention there is provided a computer entity configured for collecting an image data describing a trade mark, said computer entity comprising:

at least one data processor;

at least one data storage device;

an interface capable of inputting an image data file containing image data describing a trade mark;

said data storage device containing a set of program instructions for controlling said processor and said memory to operate said interface.

According to a ninth aspect of the present invention there is provided a display interface for inputting a data describing a trade mark, said display interface comprising:

a first view, said first view configured to display on a video screen of a computer entity;

a second view, said second view being contained within said first view, said second view comprising at least one data entry component selected from the set:

a text data entry component capable of entering a text string comprising said trade mark;

a trade mark description data entry component capable of inputting text data describing said trade mark;

an image data input component capable of inputting an image data describing said trade mark;

an audio data input component capable of inputting an audio data describing said trade mark;

wherein said second view occupies a displayed area on said video screen, of no less than 70% of a visible displayed area of said first view.

Further features of the invention are recited in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically components of an on-line transaction system for enabling instructions for filing trade mark rights to be carried out on-line over a communications network;

FIG. 2 illustrates schematically hardware and software components of the transaction system of FIG. 1;

FIG. 3 illustrates schematically an overall logical architecture of a transaction system comprising the system of FIG. 1;

FIG. 4 illustrates schematically a data model describing relationships between different data types according to a specific implementation of the present invention;

FIG. 5 illustrates schematically an architecture for layout of display views produced by an interface according to a specific implementation of the present invention;

FIG. 6 illustrates schematically data fields of an order file, illustrating different types of data to be collected by the transaction system of FIG. 1;

FIG. 7 illustrates schematically a process flow diagram for construction and operation of the transaction system according to the best mode specific implementation;

FIG. 8 illustrates schematically an interactive display interface, for collection of trade mark data according to a specific implementation of the present invention;

FIG. 9 illustrates schematically a screen display at a user computer entity showing an order page generated by an interface;

FIG. 10 illustrates schematically a file selector window display generated for allowing a human user to select a file from a file system of a user computer, where the selected file describes a trade mark;

FIG. 11 illustrates schematically process steps carried out for data input into the interface of FIG.8, for entering data describing a trade mark;

FIG. 12 illustrates schematically communication and interaction between a user computer, transaction computer and service provider computer, for inputting of data describing a trade mark, and transmitting that data over a communications network to be accessible by a human service provider operating the service provider computer; and

FIG. 13 illustrates schematically a portion of an order file viewable from a service provider computer, and served by a transaction computer, enabling a human service provider to gain enough data to define a trade mark.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification the term “trade mark” means any sign capable of being represented graphically. Trade marks include, but are not limited to, marks used in the course of trade, service marks, used in the course of providing a service, sounds, smells, images, logos, devices, colors, letters, numerals, the shape of goods or their packaging. The term “mark” will be construed as having a same meaning as the term “trade mark”.

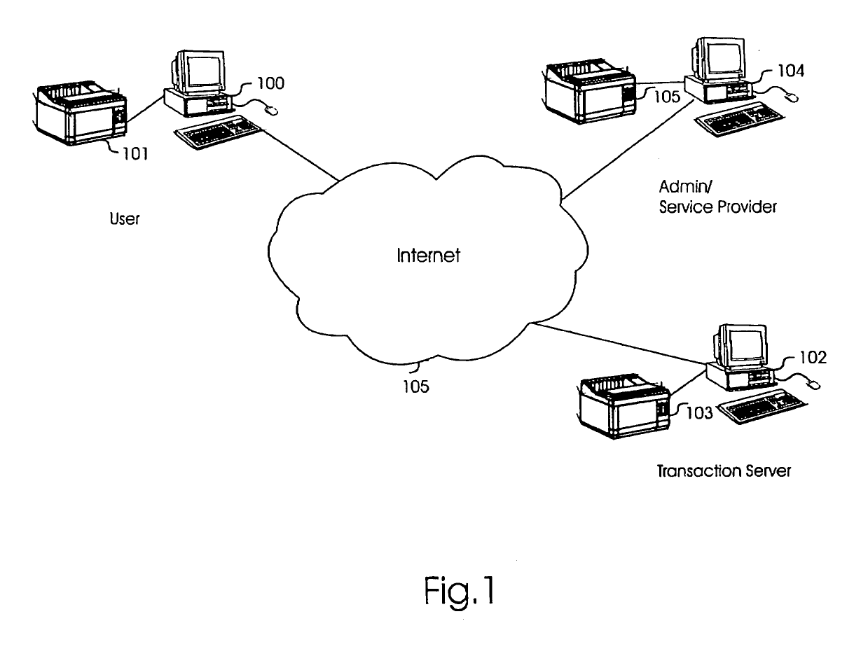

Referring to FIG. 1 herein, there is illustrated schematically components of a transactional system according to a best mode implementation of the present invention. The system comprises one or a plurality of user terminals 100, being conventional personal computers, Macintosh® computers or the like, being provided with a conventional browser, and having access to a conventional printer device 101 for printing hard copy of received e-mail documents and/or screen views; a transactional computer 102, with optional associated printer device 103, operating to provide an on-line interface display accessible by each of the user terminals 100, and generating an administration interface display, accessible to modify or enter data relating to trade marks, including geographical zones, costs, laws and procedures and the like, the transactional computer capable of carrying out on-line transactions for the fulfillment of orders and instructions for filing of trade mark rights by a service provider entity; and a service provider computer 104, comprising a conventional PC, Macintosh® computer, or the like, equipped with a printer 105, and a conventional browser, the service provider computer 104 operable to access the transactional computer 102 to receive transaction orders collected by the transactional computer, and apply changes of data relating to trade marks, on stored data bases of the transactional computer 102.

The transactional computer 102, can communicate with the user computers 100 via a known communications network, for example a virtual private network, wide area network, local area network, or the internet 105 as are known in the art; and similarly the transactional computer 102 can communicate with the service provider computer 104. The service provider computer 104 can communicate with the user computer 100 via e-mail as is known in the art.

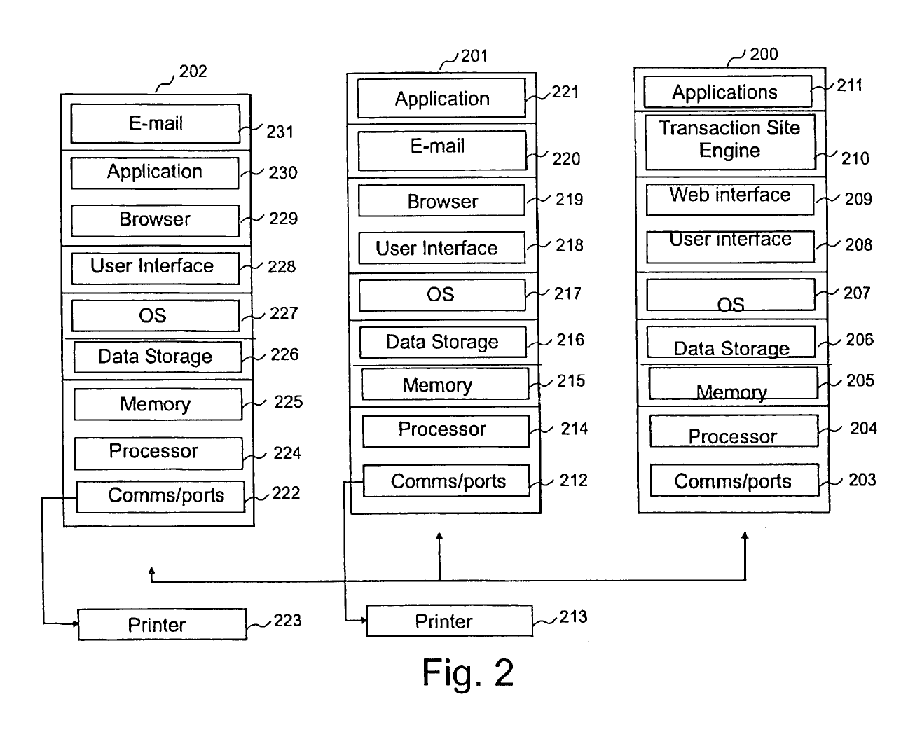

Referring to FIG. 2 herein, there is illustrated schematically components of a transactional computer 200, a service provider computer 201, and a user computer 202 of the system of FIG. 1. Transactional computer 200 comprises a communications port 203; a data processor 204; associated memory 205; a data storage device 206, for example a RAID array or the like; an operating system 204, for example the known Windows 2000®, Unix®, or Linux® operating systems; a user interface 208, for, local administration of the transactional computer, comprising a video monitor, key board, and pointing device such as a mouse or the like; a web interface 209 for displaying HTML web pages to the one or plurality of user computers 202 and one or a plurality of service provider computers 201; and a transaction site component 210. The transaction site component 210 in the best mode is implemented as code for operating the processor, memory and data storage devices 204-206 of the transactional computer, under control of operating system 207 to provide functionality for generation of and display of web pages, receiving transaction orders, and forwarding transaction orders to the user computer 202 and service provider computer 201 over a communications network, for example the internet, and for providing access to administration functionality for modification of data stored within the web server computer, by service provider computer 201.

The transaction site component 210 in the best mode is implemented as program instructions in a known programming language such as C, C++, or the like, and utilizing HTML for generation of page displays.

Service provider computer 201 comprises a communications port 212, for example a conventional modem for connecting with the transactional computer 200, and also a printer port and driver for driving a printer 212 for printing out a hard copy receipt and order confirmation of received transaction instructions; a data processor 213, for example an Intel®, or the like, processor; associated memory 214 as is known in the art; a data storage device 215, for example a hard disk or an array of hard disks drives; an operating system 216, for example the known Windows 95®, Windows 98®, Windows 2000® or Windows NT®, Unix® or Linux® operating systems; a user interface 218 comprising a video display monitor, a keyboard, for data entry purposes, and a pointing device e.g. a mouse and a set of audio speakers as is known in the art; a browser 219, for example a known Netscape® browser or the like; a conventional e-mail application 220 for receiving and sending e-mails; and one or a plurality of applications 221, for example graphic applications, audio applications or the like, for opening a wide variety of different file types, for example JPEG, .WAV, PDF, MP3, MPEG, HPGL, or similar files, so that physical printed copy of images containing graphic files can be generated using the printer 213. Similarly, where audio applications are provided, a user can play a sound over a set of speakers contained in the user interface 218.

The user computer 202 can be any computer entity available to be connected on-line, for example any known computer entity which is internet enabled, as is known in the art, and comprises a communications port 222, optionally with a printer driver for driving a printer device 223; a processor 224, including any known processor type, for example an Intel® processor or the like; memory 225 as is known in the art, a data storage device 226, for example a hard disk drive; a known operating system 227 for example a Windows®, Macintosh®, Unix®, or Linux® operating system; a known user interface 228 comprising a visual display monitor, keyboard, pointing device e.g. mouse or the like, or a web interface; a known browser 229 for example a Netscape ® browser; optionally a graphics application 230 for storing and/or scanning in image data describing a graphical trade mark and storing that image data as a file, for example a JPEG file, PDF file or the like; and optionally an e-mail application 231 for sending and receiving e-mails.

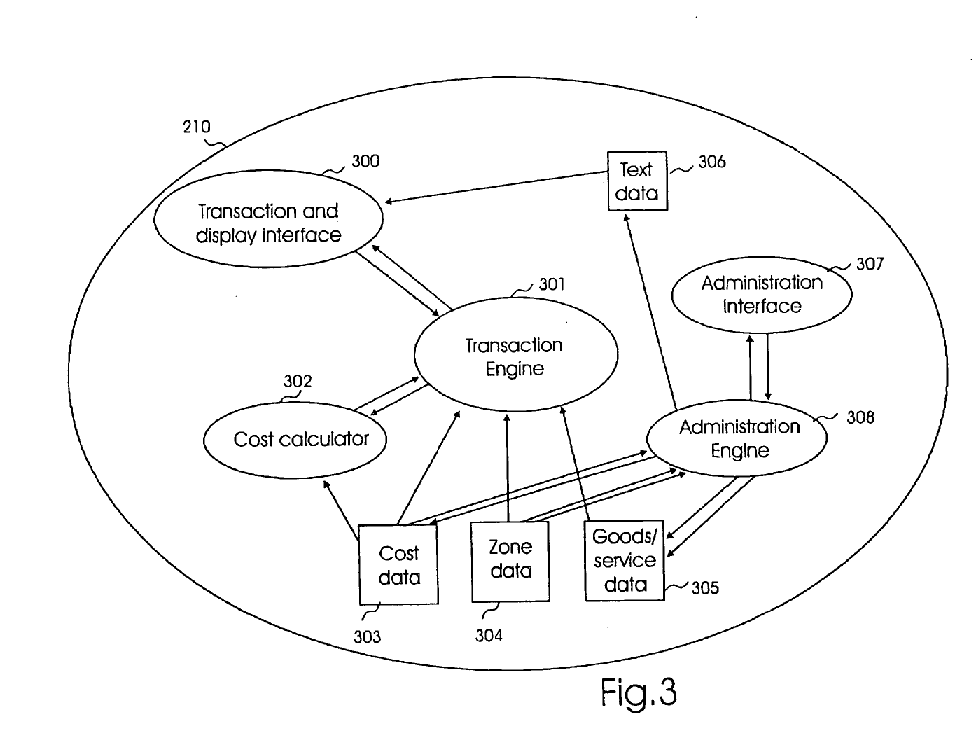

Referring to FIG. 3 herein, transaction site component 210 comprises a transaction and display interface 300 for generating an interactive graphical display capable of displaying information and inputting data; a transaction engine 301 for receiving data input via the display and transaction interface 300; a cost calculator engine 302 for calculating costs corresponding to different trade mark applications in different countries having different numbers of classes of goods and services; a cost data base 303 storing tabulated data on costs for different countries; a zone data base 304 for storing a list of countries, geographical regions or zones in which trade mark protection can be applied for; a goods/services data base 305 containing text describing lists of goods and services according to a classification system, in the best mode the known Nice international classification system for goods and services but in other embodiments, including national classifications, such as the German class system; a text data file 306 for storing text data describing procedures and information relating to trade marks and a service provider; an administration interface 307 allowing the service provider computer to modify data contained in the cost data base 303, zone data base 304 and the goods/services data base 305, and also to allow the service provider to view details of transaction orders received and print out details of transaction orders received; and an administration engine 308 for providing functionality for driving the administration interface 307.

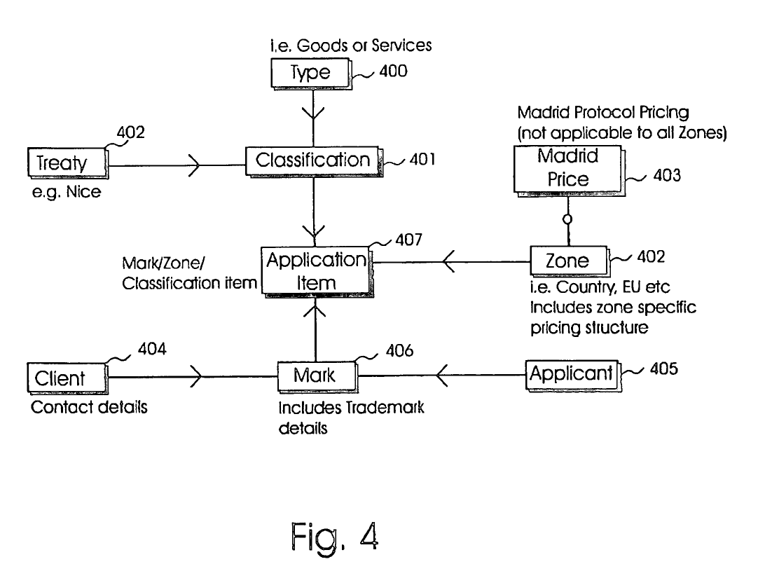

Referring to FIG. 4 herein, there is illustrated schematically a data model describing relationships between data types stored in and collected by the transaction site component 210. In FIG. 4, a directional arrow indicates a one to many relationship and a link line having an open circle represents an optional relationship. Data types include:

goods/services type data 400 describing individual text items of goods or services;

classification data 401 describing individual class headings of goods/services according to one or more national or international classification is treaties;

treaty data 402 describing international treaties relevant to the classification data, for example the Nice Agreement, and/or individual classification systems for individual national trade mark offices;

zone cost data 402, describing for each of a plurality of geographical zones, for example individual States or regions such as the European Union, costs for filing and or prosecuting trade mark applications in those zones, where each zone has a corresponding respective trade mark application filing cost and/or registration cost assigned;

international zone cost data 403, describing alternative costs for each of a plurality of zones (individual countries or regions such as the European Community) of which trade mark rights can be filed in as part of an international procedure, for example the Madrid Protocol and/or Madrid Agreement;

client contact detail data 404 describing names of one or more legal persons to whom a service provider has a client relationship with;

applicant data 405, describing a name of one or more legal persons who are to be recorded as applicant(s) for one or more trade mark applications;

mark data 406, comprising data describing a trade mark, which may be in the form of text data, image data, and/or audio data; and

application item data 407 describing a connection and relationship between a mark data, zone data and classification data, the application item data 407 constituting enough information for a service provider to perform a trade mark filing operation at a governmental or intergovernmental trade marks office on behalf of the applicant and/or client.

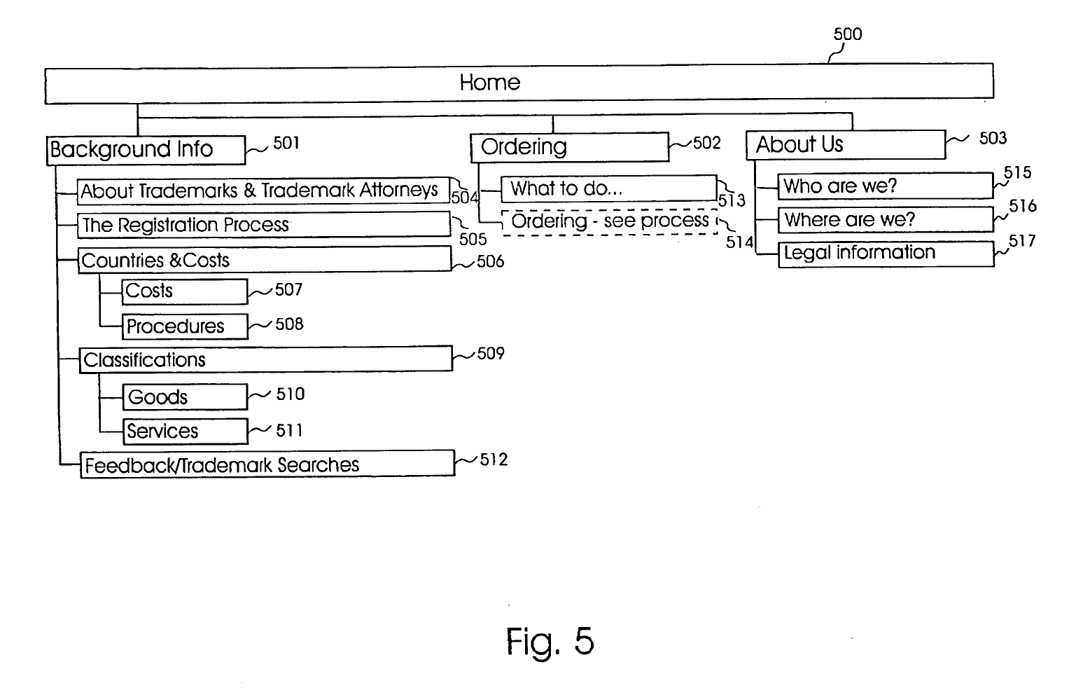

Referring to FIG. 5 herein, there is illustrated schematically a layout architecture for display of page and interface views by the transaction site.

A home page 500 is displayed when a user first connects to the transaction site. From the home page, by activating link icons as is known in the art, a user can cause display of either a background information page 501, an ordering interface 502 or an information page 503 describing details about the service provider. In the best mode the home page 500 is configured such that an icon leading to the ordering interface 502 is visually more highly prominent than icons leading to the background information page 501, or service provider information page 503, so that the natural next step of a user is activating that icon which leads through to ordering interface 502 which naturally leads through to an interactive ordering process 514, assisted by an information display 513 on how to perform that process.

Background information page 501 leads through to a trade mark attorney page 504 containing text description explaining who trade mark attorneys are and/or what trade mark attorneys do; a registration process page display 505 containing text data describing a trade mark registration process in one or more countries; a countries and costs page 506, containing text describing a list of one or more countries and associated costs for filing and/or prosecution of trade mark rights in those countries, the countries and costs page comprising a costs section 507 describing costs and a procedure section 508 describing procedures; a classifications page 509, for describing a plurality of goods or services divided into a plurality of individual classes; and a trade mark searches page 512 describing information relating to the purpose of and procedures for performing trade mark searches,

Since one objective of the transaction system is to obtain a firm instruction for filing one or more registered trade mark applications, the service provider ideally does not wish the user to become distracted from the basic operation of data entry leading to a firm instruction for filing a trade mark application. A new user is unlikely to instruct a registered trade mark application, unless the user is satisfied that they understand what they are doing. Therefore, the objective as far as the service provider is concerned, is to draw the user into a data entry process for including entry of a data describing a trade mark, without getting lost, becoming frustrated, or clicking away into cyberspace before a trade mark data entry is completed.

Service provider information page 503 comprises a section 515 describing who the service provider is, a section 516 describing physical and/or logical address details of a service provider and a legal section 517 containing legal information, contractual information concerning the service provider and/or a legal relationship between a service provider and a user or potential user of the transaction site.

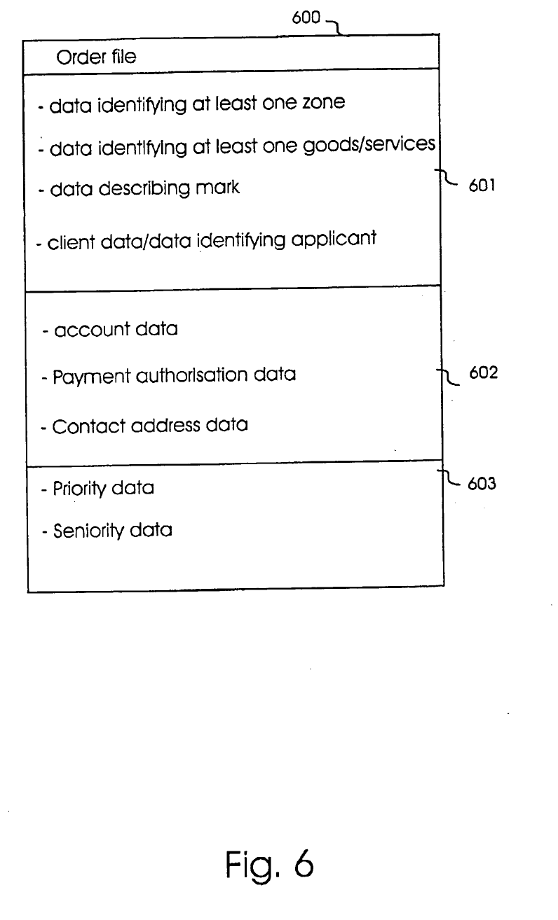

Referring to FIG. 6 herein, there is illustrated schematically an order data file containing a set of data fields for the fulfillment of an on-line transaction order for filing a trade mark application, and which enables a service provider to fulfil the order without the need for manual intervention in contacting the user, for example by telephone, email or fax.

The data types can be classified into three sets 601-603; a first set 601 of essential data; a second set 602 of preferred data; and a third set 603 of optional data. If any of the data types identified in the first set 601, are not collected by the transaction interface 300 then the process of instructing a registered trade mark application order is not fully automated but will require manual intervention from the service provider to contact the user, or alternatively the user contacting the service provider direct.

The minimum data types 601 comprising the order file include:

data identifying at least one zone or region in which a trade mark application is to be filed;

data identifying at least one item of goods and/or services for which a trade mark application is to be filed;

data describing the trade mark itself, which can be text data, image data or audio data or any combination thereof; and either

client data, comprising data identifying a client as a legal person, including client address data and client contact detail data, and/or

data identifying the name of the applicant as a natural legal person or legal entity.

The above data items must be collected in order to allow a service provider to perform a valid trade mark application filing operation.

The order file also contains a second set of data 602 which, whilst not absolutely essential for the filing of a registered trade mark application, a service provider is unlikely to wish to provide the trade mark filing service unless the second data types are provided by a user. These data types include:

data identifying a financial account, either a credit card account or bank account;

authorization data enabling collection of payment from the financial account; and

a contact address data identifying a person to whom the service provider can refer in respect of the application, the contact address data comprising either a telephone number, an email address and/or a physical address.

A third set of data 603 represents data which ideally the service provider would collect automatically through the on-line transaction system, but for which failure to make immediate collection of does not necessary prohibit the service provider from fulfilling an order. Data types in the third set include:

Priority data describing one or more earlier trade mark applications in the same or different countries, from which the user wishes to claim priority for a present trade mark application, subject of the order.

Seniority data, comprising data required for making a valid seniority claim in the case of European Community trade mark application.

Data describing the trade mark is an essential data to be collected before the operation of filing a registered trade mark application can proceed. Failure to collect the correct data describing the mark potentially results in an application for the wrong trade mark being filed by the service provider, which cannot be rectified after filing. It is therefore important, that the process of entering a data describing a trade mark is carried out efficiently and as simply as possible, in the interactive ordering process 514.

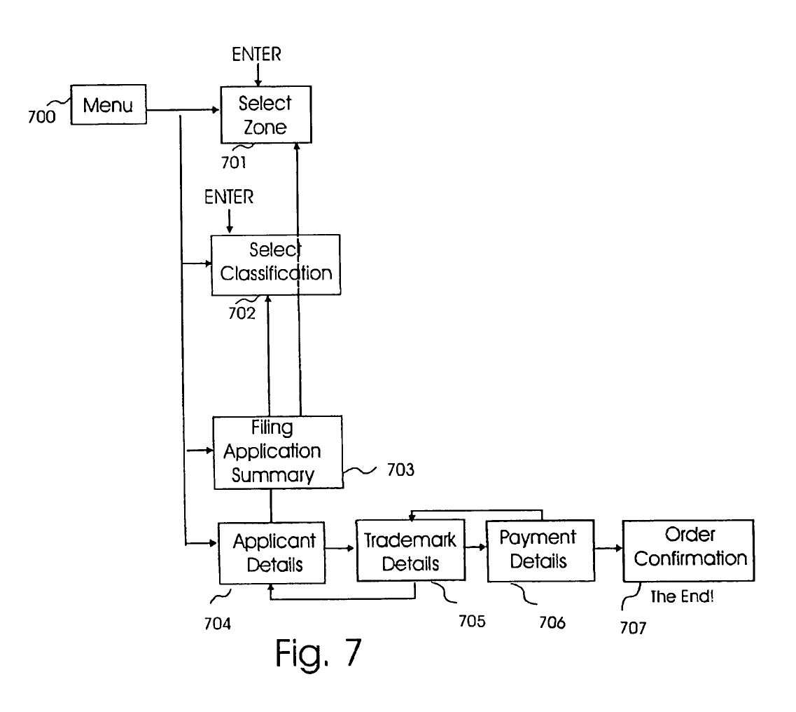

Referring to FIG. 7 herein, there is illustrated schematically a process flow diagram, illustrating a logical process flow for generating and operating an interactive interface display, and for governing a sequence of data input via the interactive interface display, according to the best mode implementation of the present invention.

A process for collection of data for filing a trade mark right commences in menu process 700 by selecting the ordering process 514 from the home page 500. The ordering process 514 builds an order file containing at least a minimum data required in order for the service provider to fulfil the trade mark application order automatically, and without the need for the service provider to refer to the user by manual intervention (for example telephoning the user or sending an email to the user requesting further data).

In select zone process 701, a user selects a country via an interactive ordering interface display. In select goods/services process 702, the user selects at least one class of goods or services which applies to the trade mark. In filing summary process 703, there is displayed one or a plurality of selected trade mark filings, specifying country and classes of goods and services.

The user can commence data entry either in the select zone process 701, or in the select goods/services process 702. The select zone and select goods/services processes are presented on a single screen display of the interface, and the user can input zones, and for each zone a list of goods/services in one or more classes of goods/services, to build up a plurality of trade mark filings which are displayed and which can be modified in the filing summary process 709. The user can move between the select zone process 701, select goods/services process 702 and filing summary process 709 in any order and can switch backwards and forwards between these processes. If in process 703, at least one class of goods and services has not been selected then optionally, a user is prompted, to enter at least one class of goods and services.

The process then continues through an applicant details data entry process 704, followed by a trade mark details data entry process 705 and a payment details data entry process 706 followed by an order confirmation process 707.

Each of the applicant details process 704, trade mark details data entry process 705 and payment details process 706 have a different screen view presented on the interface, and the user can move backwards or forwards along the sequence of applicant detail, trade mark detail, and payment details processes, to make sure that the data entries made are correct, before proceeding to the order confirmation process 707.

There will now be described operation of the transaction system for collection of data describing a trade mark.

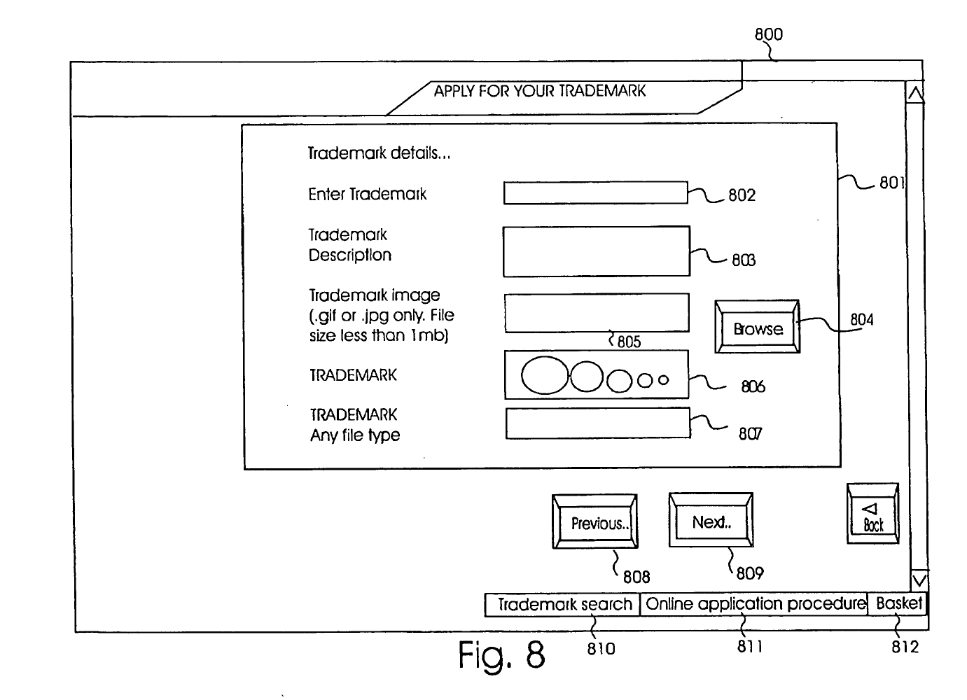

Referring to FIG. 8 herein, there is illustrated an ordering page display 800 presented by the display interface 300 when a user enters ordering process 514. The ordering page display comprises a substantially rectangular display having a ratio of width dimension to height dimension in the range width 0.5 to 1 to height 0.5 to 1. The ordering display 800 comprises a trade mark view 801 for entering details of a trademark.

The trademark view 801 comprises a text dialogue box 802 for entering a trademark consisting of words only; a dialogue box 803 for entering a written description text of a trademark, for example where the trademark is a sound or a smell, a written description of that sound or smell; a browse facility activated by browse icon 804, for browsing a users internal data storage device to find an image data file or audio data file, where the trademark is a logo or image which can be represented in graphical form as image data or as audio data; a trade mark image file entry window 805, for entering an image data file; a trade mark image display 806, for displaying an image of a trade mark to a user, and a data file entry dialogue box 807 capable of inputting a trade mark data file of any file type.

The trademark application display also comprises a “previous icon” 808 which leads back to a previous display (the applicant detail display) and a next icon 809, which leads to a next display, being a payment details display as will be described hereinafter.

The ordering page 800 interface also comprises a plurality of icons 810, 811, 812 leading respectively to displays for ordering a trademark search, reading information about the online procedure for applying for trademarks, and checking one or a plurality of already reserved application items.

Trade mark text dialogue box 802, is capable of accepting text string characters, such as ASCII characters, typed in from a keyboard of a user computer. The text characters include all ASCII symbols, including upper and lower case symbols. ASCII characters entered into the text dialogue box 802, are used to represent a trade mark, and are suitable for word marks, personal names, invented words and the like.

Trade mark description data entry box 803 is capable of inputting ASCII text characters, for entry of a written description of a trade mark. For example, where the trade mark is a smell, a written description of the smell may be entered, for example “the mark consists of a mixture of lavender and peppermint”. The trade mark description data entry box 803 can be used to describe any type of trade mark for which registration is required, irrespective of whether the mark is a smell, sound, image, word, name or any other type of trade mark as long as the mark is capable of being described by written description.

Trade mark image data entry box 805 is capable of inputting an image data file. The types of image data file acceptable by the image data entry box 805 may be restricted, for example to .GIF or .JPG files or to any other type of image files supported by the transaction computer. A file is selected from a user computer's file system, or from elsewhere as a networked computer. The file path is displayed in the data entry box 805. In order to input a file in a particular format, and be able to display an image corresponding to that file, the transaction server must be equipped with a corresponding application capable of opening the file, and serving an image display back to the user computer via the trade mark view.

The trade mark image display 806 comprises an area of the view in which an image is displayed, corresponding to an input image file entered into the trade mark image data entry box 805. Display of the image in the trade mark image display 806, contained in a file whose path name has been entered in the trade mark image data entry box 805 allows a user to visualize the image of the mark which is being submitted to the service provider via the transaction computer, for application as a registered trade mark.

File entry box 807 is capable of receiving a file of a plurality of different types, for example image data files, audio files, text files, files defining a frequency spectrum of a sound, or color or the like or amplitude data defining amplitudes of components of a sound or a color. Upon selecting a file type and entering a file path name into the data entry box 807, a file containing data describing a trade mark is transferred from the data storage device of the user computer, across the communications network to the transaction computer.

The trade mark view 801, in the best mode, occupies as large an area of the ordering page display 800 as possible. Bearing in mind that different users may have different legacy user computers, having a variety of browsers, the available screen view presented by the browsers is restricted by the size of a monitor of the users computer entity, and by the functionality and capability of the browsers.

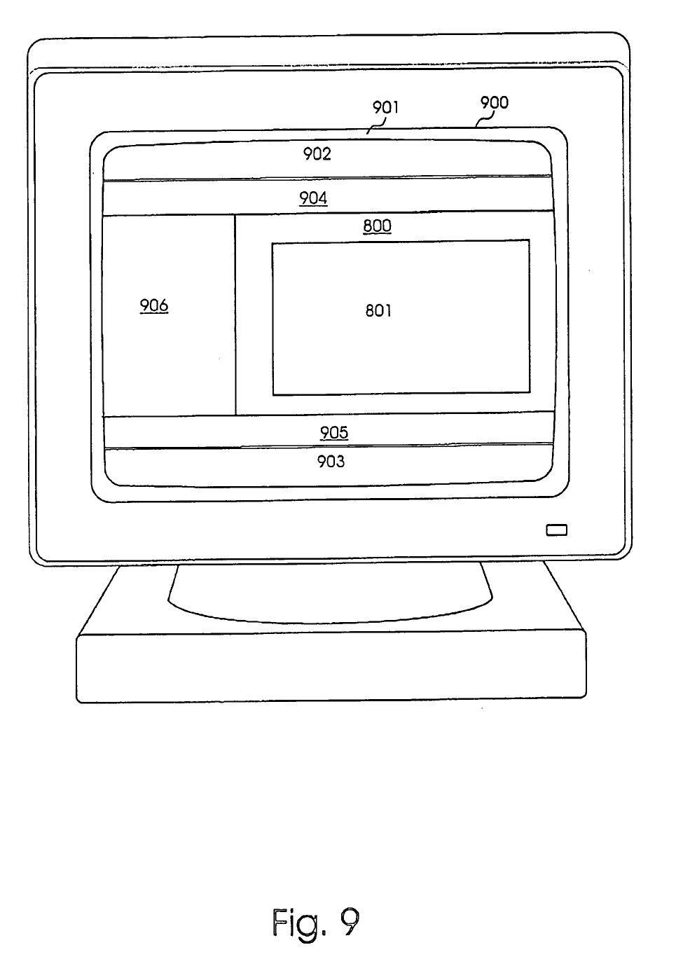

Referring to FIG. 9 herein, there is illustrated schematically a screen view as seen by a user at a user computer 100, on a monitor of the user computer. The monitor comprises a screen 900. At the edges of the screen typically there may be a margin region 901 which is dark, so that the view on the screen does not extend up to the perimeter of the screen. This means that effectively the maximum viewable area on a screen having external dimensions 285 mm width, 220 mm height, may be only a rectangular area of, for example 217 mm width, and 210 mm height. Within the visible display, an upper toolbar 902 is generally present, for any applications which are open, and a lower toolbar 903 is generally present, for example in the known Windows® 2000 screen, with various menu items. In order to view the ordering page display 800, the user opens a browser, which adds its own upper toolbar 904, lower toolbar 905, and optionally, occupies other areas of the screen for example area 906 which may be open as a “favourite” menu selector. This means that the visible area actually occupied by the ordering page display 800 may be as little as 40% of the nominal screen area 900 on the users visual display monitor. Within the ordering page display 800, the trade mark view 801 is likely, at maximum, to occupy 80-90% of the area of the ordering page display 800, leaving space for other icons present on the ordering page display 800.

Consequently, the presented area of the trade mark view 801, on a nominal 14″ (360 mm) screen may be an area in size of around 35% of the total screen area, assuming maximization of the trade mark view 801 as a percentage of the total area of the ordering page 800, and assuming that a typical known browser and a typical known legacy monitor device are used. This gives a restricted area in which to complete entry of trade mark data, and in which to implement a layout of screen which will enable a user to enter trade mark data in an efficient manner, without having to scroll, or clicking away into other features.

In the best mode implementation trade mark text dialogue box 802, trade mark description data entry box 803, trade mark image data file entry box 805, trade mark image display area 806, and file entry box 807 are visible simultaneously within the trade mark view 801 on a users screen display, without the need to scroll the trade mark view. Therefore, the user is presented with visual information in a single view without scrolling, which enables the user to immediately ascertain that the data describing a trade mark can be entered in a variety of different forms including text, image file, or files of other types.

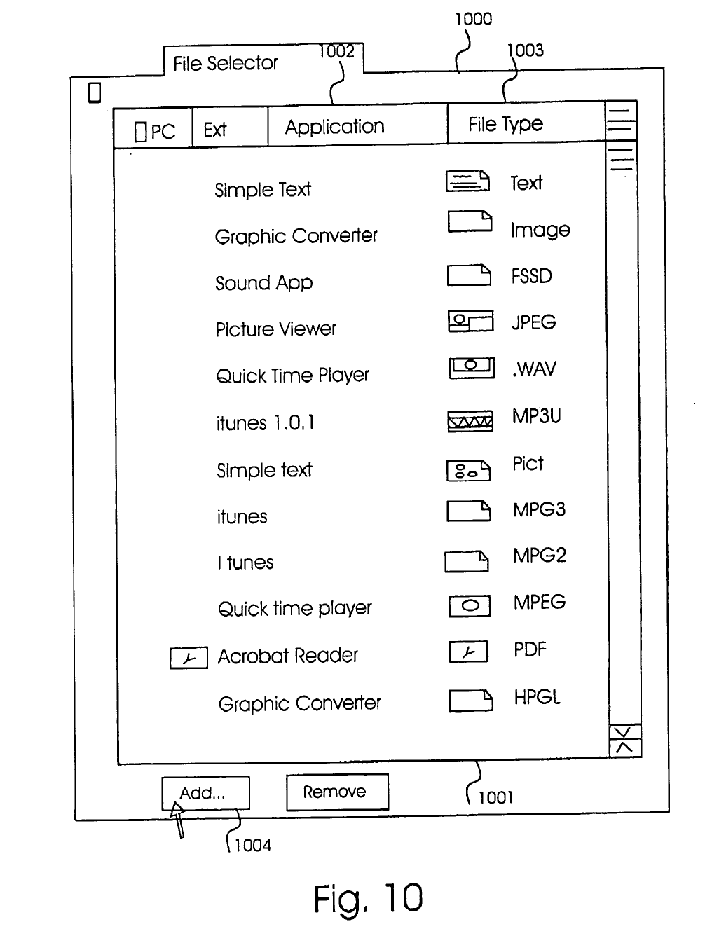

Referring to FIG. 10 herein, there is illustrated schematically a browse view, displayed upon activation of browse icon 804, for browsing files and selecting files within a file system of the user computer.

The browse view comprises a file selector window 1000, the file selector window overlaying the trade mark view 801, and listing a plurality of files within a file system of the user computer, in a file list 1001. Within the file list, each file is categorized by application 1002 and file type 1003. Files of a plurality of different types may be listed within the file selector window 1000, including text files, image data files, .GIF, JPEG files, .WAV files, MP3U, picture files, MPG2, MPG3, MPEG, PDF and HPGL files for example. The file selector window 1000 comprises an “add” icon 1004, activation of which adds a user highlighted file name and path to either the trade mark image data entry box 805, or the trade mark file data entry box 807, depending upon which box has been highlighted by the user within the trade mark details view 801.

Attempts to add a file to the trade mark image input box 805, where the file is not of one of the acceptable types, for example .GIF, or .JPG, results in the file being added to the generic trade mark file type box 807. Selection of a file from the file selector window 1000 results in the path name of the file being entered in either the trade mark image data entry box 805, or the file entry box 807, where the file is of a type not recognized by the trade mark image data entry box 805. In the case of entering a file type into the file entry box 807, an image is not displayed in the trade mark image display 806.

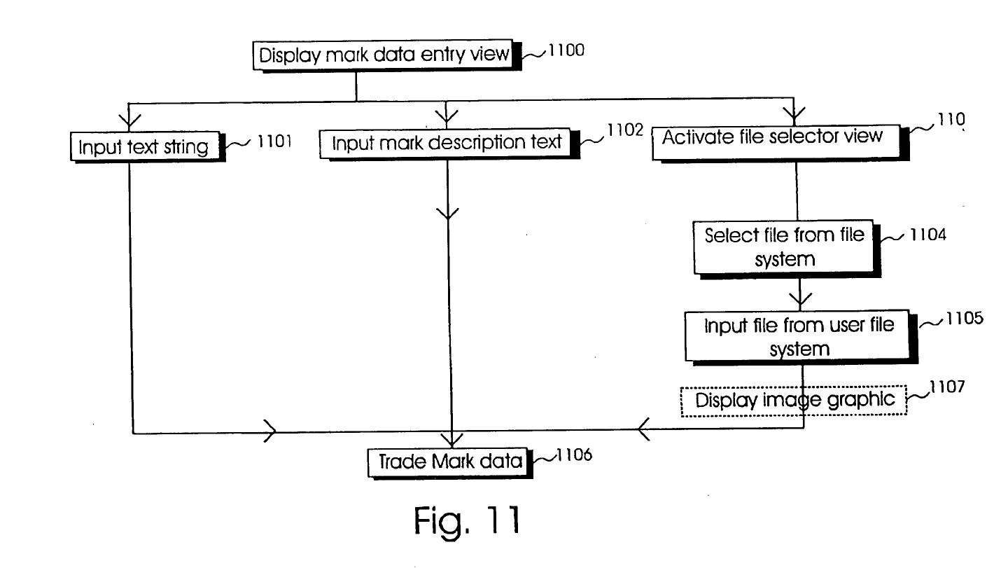

Referring to FIG. 11 herein, there is illustrated schematically operation of the transaction computer and user computer, for input of data describing a trade mark file. In step 1100 the user interface displays the trade mark view 1001 as described herein before. From the display, the user can, in any order, input data describing a text string in process 1101, input data describing a description of a trade mark in the form of text in step 1102, or activate the file select a window 1000 in process 1103 for inputting a file of any type, e.g. image, text or audio or graphic. Where the file selector window 1000 is activated, in step 1104, a user selects a file from the internal file system of the user computer. It will be understood by those skilled in the art that many different types of prior art file system are known, and the exact file system depends upon the particular user computer which is being used. In step 1005, having selected a file from the file system, the file is entered into the transaction system computer over the communications network, by activation of “add” icon 1004. The resulting trade mark data 1106 is sent to the transaction computer over the communications network.

After entering the file from the user file system input, optionally, the trade mark view may display an image contained in a graphics file or image data file, where the transaction server has an application capable of opening the file, and serving back to the file to the user, showing an image or graphic contained in an image or graphic file.

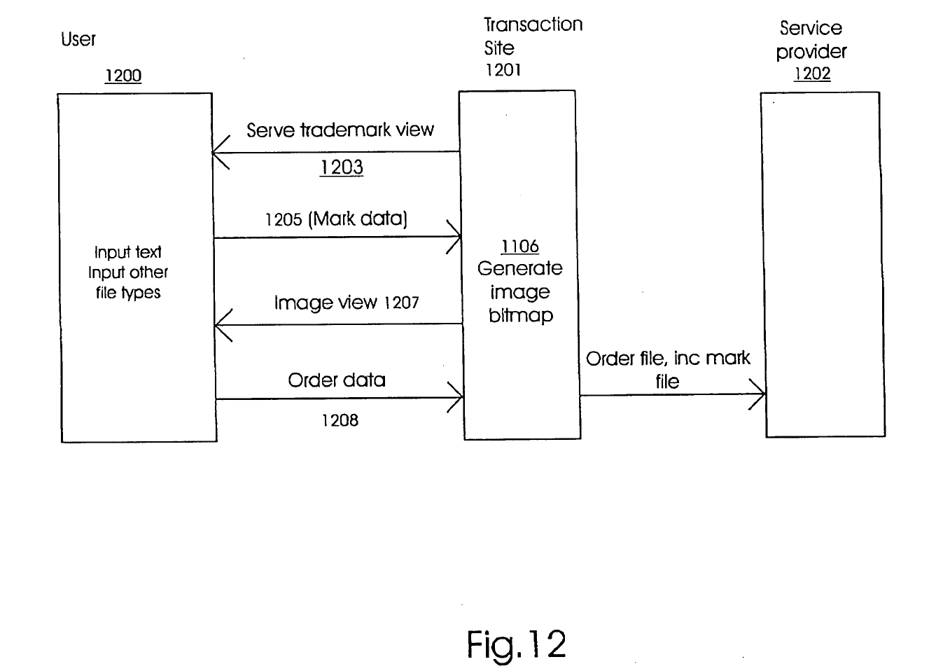

Referring to FIG. 12 herein, there is illustrated schematically communications between a user computer 1200, a transaction computer 1201, and a service provider computer 1202. The user computer reads a display view as described with reference to FIG. 8, generated by the transaction site computer 1201, allowing a user at the user computer to enter details into the trade mark view 801. In process 1204, a user enters text data describing a trade mark and/or data describing the trade mark itself, for example in the form of input text characters, or by input of a file stored on the data storage device of the user computer. In step 1205, the trade mark data is sent over the communications network to the transaction site computer 1201. Where the input mark file comprises image data, in step 1106, the transaction site computer opens an application to read the image data, and generates a bit map from that image date. The bit map is added to the interface display, allowing the user at user s computer 1200 to view a bit map image on the trade mark view 801 in real time. When a full order data is complete, comprising applicant details, mark data, payment details, and data describing a specification of goods/services, order data is sent to the transaction site computer 1201 in process 1208. The transaction computer displays or pro-actively sends, depending upon how the transaction computer is configured, an order data file to service provider computer 1202. The order data file comprises data including applicant name, payment details, a list of goods/services, and the trade mark data. The trade mark data can be in any form including text, image data files or audio files, and may include a data file read from the user computer, and forwarded to the transaction computer 1201. Where the transaction computer does not have an application capable of opening the mark data file, for example because the mark data file is of a file type where the transaction computer does not have the correct application or version of application to open this, the file is simply forwarded onto the service provider computer 1202. At the service provider computer, an array of applications are provided. In a best mode implementation a large number of applications of different versions are provided, enabling the service provider to open almost any type of data file which is likely to be sent by a user. In order to successfully obtain information describing a trade mark in a form which is readily understandable to a human user, an application must be used to open the mark data file transferred from the user computer. The larger the number and variety of applications stored on the service provider computer, then the wider the range of different file types which can be used to describe a trade mark.

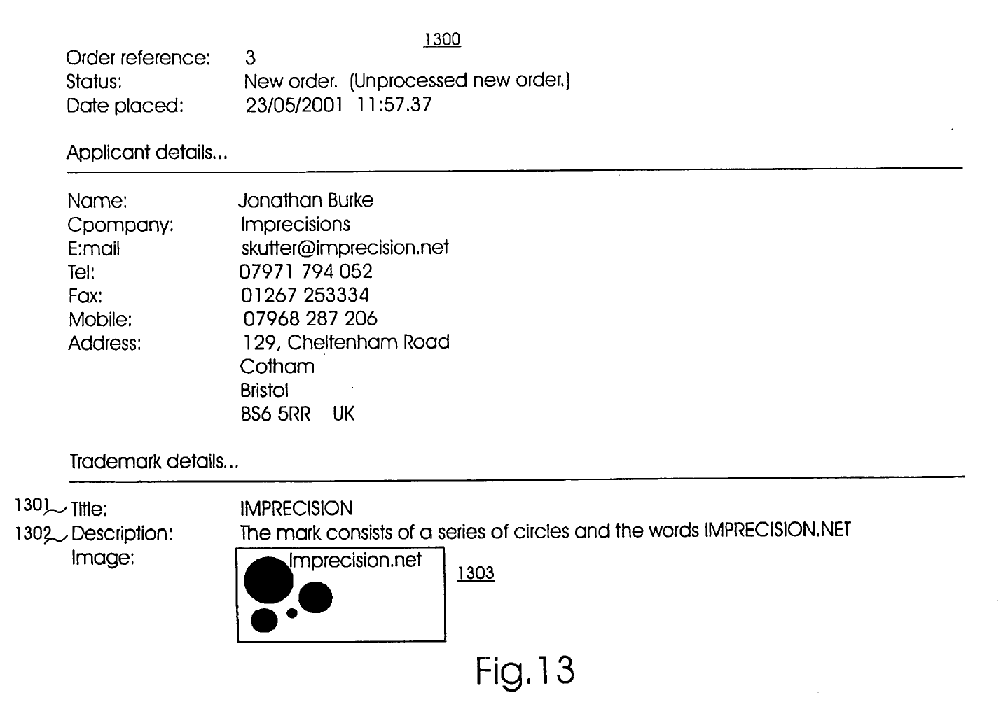

Referring to FIG. 13 herein, there is illustrated schematically one example of part of an order data file showing applicant details, and trade mark details. The example of FIG. 13 shows a paper print out, of part of an order data file. The data displayed on the paper print out may also or alternatively be displayed on a video monitor at the service provider and/or at the transaction computer. In this case, the trade mark details includes a text input of a trade mark, in this case the text IMPRECISION, as well as a text description describing the mark. In this case, the text description consists of “the mark consists of a series of circles and the words IMPRECISION.NET”. The text description is contained in a text description field 1302.

An image of the mark may be included in the order file, which is produced at the transaction computer and is viewable and/or receivable by the service provider computer. The image is contained as an electronic image data file, received at the service provider and can be printed in two dimensional graphical format in an image data field 1303 of an order data file. The order data file is viewable on screen, or can be printed on a physical print media by printer 105.

The service provider computer can print out a hard copy of the order file, thereby having a printed copy of the trade mark, in this case including a logo/device, which can then be attached to a physical paper form for filing a trade mark application by conventional methods, i.e. paper based methods. Additionally, where a trade mark data file is sent from the transaction computer, the service provider computer can open that file, using one of the array of applications provided at the service provider computer, and can print out a hard copy in the case of an image file, or graphics data file, or in the case of an audio file, can play the audio signal over a set of audio monitors. A human service provider, operating the service provider computer can then gain an understanding of the trade mark, and can manually create a definition of the trade mark, in a form suitable for filing at one or a plurality of governmental offices, by conventional means, for example described by text on a paper form.

1. An interface, for inputting data describing a trademark said interface comprising:
a data file input component, for inputting a selected data file, said selected data file comprising data describing a trade mark; and
a browse component for enabling a user to browse a file system of a user computer entity, and select said data file from said file system.

2. The interface as claimed in claim 1, wherein said selected data file comprises data capable of representing a mark in two dimensional form.

3. The interface as claimed in claim 1, wherein said data file comprises an image data file.

4. The interface as claimed in any one of the preceding claims, wherein said data file comprises a text file.

5. The interface as claimed in any of the preceding claims, wherein said data file comprises an audio file.

6. The interface as claimed in any one of the preceding claims, wherein said data file comprises at least one video image data.

7. The interface as claimed in claim 1, wherein said data file comprises data describing a color.

8. The interface as claimed in claim 1, wherein said data file comprises frequency spectrum data, said frequency spectrum data describing frequency components of a mark.

9. The interface as claimed in claim 1, wherein said data file comprises amplitude data, representing an intensity of a parameter of said mark.

10. The interface as claimed in claim 1, wherein said data file comprises an MPEG audio file.

11. The interface as claimed in claim 1, wherein said data file comprises an MPEG video file.

12. The interface as claimed in claim 1, wherein said data file comprises a JPEG file.

13. The interface as claimed in claim 1, wherein said data file comprises a PDF file.

14. The interface as claimed in claim 1, wherein said data file comprises a .WAV file.

15. The interface as claimed in claim 1, wherein said data file comprises an MP3 file.

16. The interface as claimed in claim 1, wherein said data file comprises an ASCII character file.

17. The interface as claimed in claim 1, wherein said data file comprises a bit map file.

18. A transaction system for collecting data describing a trade mark, said transaction system comprising:
a transaction computer entity, said transaction computer entity operating an interface, said interface capable of accepting a data file representing a trade mark;
at least one user computer entity, said user computer entity comprising a browser, and a file system;
wherein said interface allows said browser to:
browse said file system of said user computer entity;
select a data file stored on a data storage device of said user computer entity; and
said interface inputs said selected data file to said transaction computer entity.

19. A transaction system for collecting data describing a trade mark, said transaction system comprising:
a transaction computer entity, said transaction computer entity operating an interface, said interface capable of accepting an image data file;
wherein said interface is capable of serving a view of an image contained in said input image data file.

20. The transaction system as claimed in claim 19, wherein said interface is capable of serving a view containing an image selected from the set:
a JPEG image;
a PDF image.

21. A display interface for inputting a data describing a trade mark, said display interface comprising:
a text data entry component, capable of entering a text string comprising said trade mark;
a trade mark description data entry component, capable of inputting text data describing said trade mark;
an image data input component, capable of inputting an image data, said image data describing said trade mark; and
an audio data input component, capable of inputting an audio data file, said audio data file comprising audio data describing said trade mark.

22. The display interface as claimed in claim 21, further comprising:
a browser component, capable of activating a browse function, for finding a said image data file.

23. The display interface as claimed in claim 21, further comprising:
a browser component for enabling a user to browse a file system, for selecting a said data file.

24. A display interface for inputting data describing a trade mark, said display interface comprising:
at least one data entry component, said data entry component capable of accepting data in a form selected from the set:
text data;
image data;
video data;
audio data.

25. A method of inputting data describing a trade mark, said method comprising:
generating a display view, said display view showing one or a plurality of data entry components, for entering data describing a trade mark, wherein said data describing a trade mark can be of a data type being any one or more of the following data types:
text character data;
image data;
audio data;
video data.

26. The method as claimed in claim 25, further comprising the step of:
generating an order data file, said order data file comprising data describing said trade mark, wherein said order data file is capable of being printed in physical graphical format.

27. An electronic order data file capable of being printed in graphical format, said order data file comprising:
a field for containing a set of text characters comprising said trade mark;
a field for containing a text description of said trade mark; and
a field for containing a graphical image of said trade mark.

28. The order data file as claimed in claim 27, further comprising:
a field for containing a video data describing a trade mark.

29. A computer entity configured for collecting an image data describing a trade mark, said computer entity comprising:
at least one data processor;
at least one data storage device;
an interface capable of inputting an image data file containing image data describing a trade mark;
said data storage device containing a set of program instructions for controlling said processor and said memory to operate said interface.

30. A display interface for inputting a data describing a trade mark, said display interface comprising:
a first view, said first view configured to display on a video screen of a computer entity;
a second view, said second view being contained within said first view, said second view comprising at least one data entry component selected from the set:
a text data entry component capable of entering a text string comprising said trade mark;
a trade mark description data entry component capable of inputting text data describing said trade mark;
an image data input component capable of inputting an image data describing said trade mark;
an audio data input component capable of inputting an audio data describing said trade mark;
wherein said second view occupies a displayed area on said video screen, of no less than 70% of a visible displayed area of said first view.
